(19) United States
(12) Patent Application Publication
(10) Pub. No.: US 2021/0168292 A1
(43) Pub. Date: Jun. 3, 2021

(54) OPERATION ASSISTANCE DEVICE, OPERATION ASSISTANCE METHOD, AND RECORDING MEDIUM

(71) Applicant: SHARP KABUSHIKI KAISHA, Sakai City, Osaka (JP)

(72) Inventors: MAKOTO OHTSU, Sakai City (JP); TAKUTO ICHIKAWA, Sakai City (JP); TAICHI MIYAKE, Sakai City (JP)

(21) Appl. No.: 16/065,237

(22) PCT Filed: Dec. 15, 2016
(86) PCT No.: PCT/JP2016/087359

§ 371 Date: Jun. 22, 2018

(30) Foreign Application Priority Data
Dec. 22, 2015 (JP) 2015-250547

(51) Int. Cl. H04N 5/232; G06K 9/00

(52) U.S. Cl. CPC H04N 5/23296; H04N 5/23206; G06K 9/00711; G06K 9/00228; G06K 9/00288

(57) ABSTRACT

A video image in which an inclination angle of a captured video image is changed according to an inclination angle of an operation terminal with which an operator has captured the video image is shared between the operator and an instructor. Provided are a communication unit configured to receive the captured video image, a communication unit configured to acquire a capturing inclination of the captured video image, a corrected video image generation unit configured to change a displayed inclination angle of a received captured video image according to the capturing inclination acquired by the communication unit, and a communication unit configured to output a captured video image, in which the displayed inclination angle has been changed, to an outside.

### TECHNICAL FIELD

One aspect of the disclosure relates to an operation assistance device, an operation assistance method, an operation assistance program, and a recording medium.

### BACKGROUND ART

A videoconference device that transmits a video image captured by a camera (hereinafter referred to as a captured video image) and a voice collected by a microphone (hereinafter referred to as a collected voice) to a remote place has been widely used. Some of the videoconference devices transmit, in addition to the captured video image and the collected voice, additional screen information about a screen of application software running simultaneously with the videoconference device in a terminal run by the videoconference device (hereinafter referred to as a user terminal) and instruction information such as pointer information input to the user terminal by, for example, moving a mouse by a user of the videoconference device (hereinafter also referred to as a user).

An operation assistance device is an application of the videoconference device. For example, the operation assistance device allows a user who performs a repair operation (hereinafter also referred to as an operator) to capture an operation situation with the camera, transmits the captured video image to a user who gives instructions on an operation procedure or the like to the operator (hereinafter also referred to as an instructor), and allows the instructor to give instructions on the operation procedure or the like (hereinafter also referred to as operation instructions) to the operator while looking at a received captured video image. For the operation instructions from the instructor to the operator, the instructor provides the instruction information such as pointer information and a mark remaining for a certain period of time (hereinafter also referred to as marker information) to the captured video image transmitted by the operator, and the operator makes reference to the video image including the instruction information. Thus, an operation can be assisted more specifically than with oral operation instructions. Techniques in PTL 1 and PTL 2 are disclosed as a method for achieving such a remote operation assistance.

PTL 1 discloses a technique for superimposing instruction information on an operation spot in an actual optical image observed by an operator and displaying it. PTL 2 discloses means for an instructor to visually recognize a video image including instruction information displayed on a terminal on an operator side.

### CITATION LIST

### Patent Literature

PTL 1: JP 2008-124795 A (published on May 29, 2008)

PTL 2: JP 2015-135641 A (published on Jul. 27, 2015)

### SUMMARY

### Technical Problem

However, while a technique described in PTL 1 gives consideration to a position of a displayed indicator superimposed on a target portion in an optical image of an operation subject observed by an operator, the technique does not give consideration to an inclination angle of an electronic camera with which the operator captures a video image. While a technique described in PTL 2 gives consideration to an instruction image and a relative position being shared among a plurality of terminals on an instruction side, the technique does not give consideration to an inclination angle of a camera with which an operator captures a video image. Thus, when the operator inclines the camera and captures the video image, a direction (inclination of the video image) for the operator is different from a direction (inclination of the video image) for the instructor. For example, “up” for the operator is “upper right” or the like for the instructor. A problem arises that operation instructions cannot be appropriately provided to the operator due to a difference between the direction (the inclination of the video image) for the operator and the direction (the inclination of the video image) for the instructor.

One aspect of the disclosure has been made in view of the above-described problems, and an object thereof is to provide an operation assistance device and the like capable of assisting the instructor to appropriately provide operation instructions to the operator and of enhancing operation efficiency.

### Solution to Problem

To solve the above-described problems, an operation assistance device according to one aspect of the disclosure includes: a reception unit configured to receive a captured video image; an inclination acquisition unit configured to acquire a capturing inclination of the captured video image; a corrected video image generation unit configured to change a displayed inclination angle of a received captured video image according to the capturing inclination acquired by the inclination acquisition unit; and an output unit configured to output a captured video image, in which the displayed inclination angle has been changed, to an outside.

Furthermore, an operation assistance method according to one aspect of the disclosure includes: a reception step of receiving a captured video image; an inclination acquisition step of acquiring a capturing inclination of the captured video image; a corrected video image generation step of changing a displayed inclination angle of a received captured video image according to the capturing inclination acquired in the inclination acquisition step; and an output step of outputting a captured video image, in which the displayed inclination angle has been changed, to an outside.

### Advantageous Effects of Disclosure

According to one aspect of the disclosure, a displayed inclination angle of a received captured video image of a subject is changed according to a capturing inclination of a captured video image. Thus, operation efficiency of both an operator operating with an operation terminal for capturing and an instructor seeing the received captured video image can be enhanced.

This can assist the instructor to appropriately provide operation instructions to the operator.

### BRIEF DESCRIPTION OF DRAWINGS

FIG. 1 is a diagram schematically illustrating a situation of a remote operation in Embodiment 1.

FIG. 2 is a diagram illustrating one example of a configuration of a remote communication system according to the present embodiment.

FIG. 3 is a functional block diagram illustrating one example of a configuration of an operation terminal in Embodiment 1.

FIG. 4 is a functional block diagram illustrating one example of a configuration of an instruction device in Embodiment 1.

FIG. 5 is a diagram illustrating marker information and attributes thereof according to the present embodiment.

FIG. 6 is a diagram illustrating an example of a configuration of a communication signal according to the present embodiment. FIG. 6(1) illustrates a basic form of a data communication packet. FIG. 6(2) illustrates a video image code packet. FIG. 6(3) illustrates a video image code packet (including inclination information). FIG. 6(4) illustrates a marker code packet.

FIG. 7 is a diagram illustrating composition of a captured video image and marker information according to the present embodiment.

FIG. 8 is a diagram illustrating a method for calculating an inclination angle in the operation terminal according to Embodiment 1.

FIG. 9 is a functional block diagram illustrating one example of a configuration of a management server in Embodiment 1.

FIG. 10 is an image diagram of marker tracking processing according to the present embodiment.

FIG. 11 is a diagram illustrating marker tracking by template matching according to the present embodiment.

FIG. 12 is a diagram illustrating video image correction processing based on inclination information according to Embodiment 1.

FIG. 13 is a diagram illustrating a flowchart of the operation terminal and the instruction device in Embodiment 1.

FIG. 14 is a diagram illustrating a flowchart of the operation terminal and the instruction device in Embodiment 1. FIG. 14(1) is a flowchart of captured video image transmitting processing. FIG. 14(2) is a flowchart of composition displaying processing. FIG. 14(3) is a flowchart of new marker transmitting processing.

FIG. 15 is a diagram illustrating a flowchart of the management server in Embodiment 1.

FIG. 16 is a diagram illustrating a flowchart of the management server in Embodiment 1. FIG. 16(1) is a flowchart of video receiving processing. FIG. 16(2) is a flowchart of marker information receiving processing. FIG. 16(3) is a flowchart of marker information update processing. FIG. 16(4) is a flowchart of corrected video image transmitting processing.

FIG. 17 is a diagram illustrating a flowchart of corrected video image generating processing according to Embodiment 2.

FIG. 18 is a diagram illustrating a projective transformation in front correction processing in Embodiment 2.

FIG. 19 is a diagram illustrating a flowchart of front correction processing according to Embodiment 2.

FIG. 20 is an explanatory drawing of a method for acquiring coordinates after front correction according to Embodiment 2.

FIG. 21 is a diagram illustrating marker information and attributes thereof according to Embodiment 3.

FIG. 22 is a diagram illustrating video image correction processing based on inclination information according to Embodiment 3.

FIG. 23 is a diagram illustrating an inclination of an operation terminal and an inclination of an operator according to Embodiment 4.

FIG. 24 is a functional block diagram illustrating one example of a configuration of the operation terminal in Embodiment 4.

FIG. 25 is a diagram illustrating a method for calculating an inclination of an operator in Embodiment 4.

### DESCRIPTION OF EMBODIMENTS

Hereinafter, embodiments of the disclosure are described in detail with reference to the drawings. In the drawings, portions having the same function will be given the same reference signs and repeated description thereof will be omitted.

### Embodiment 1

In the present embodiment, a basic configuration in one aspect of the disclosure will be described.

How to Use Device

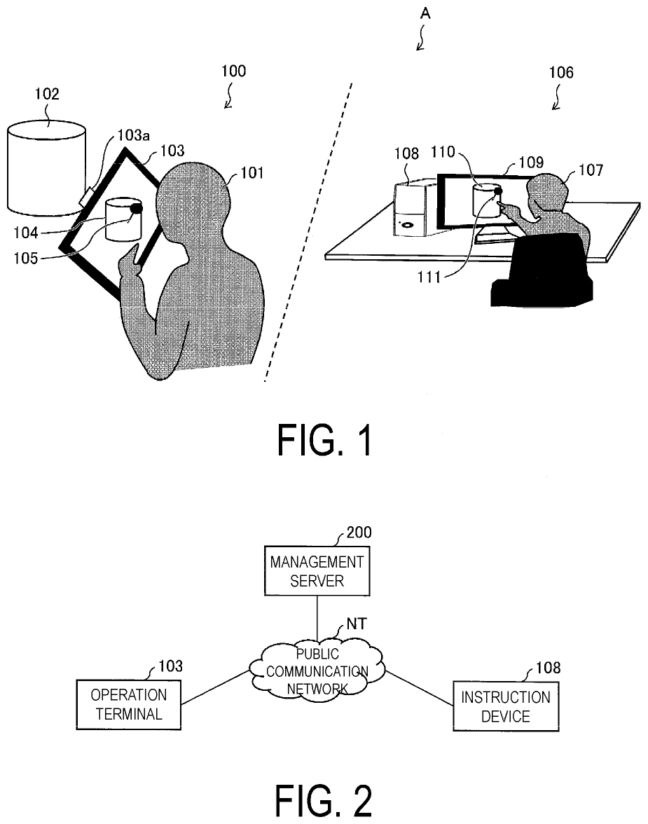

FIG. 1 is a diagram schematically illustrating a situation of remote assistance in Embodiment 1 of the disclosure capable of matching an inclination of an operation terminal with which an operator on an operator side captures a video image with an inclination of a video image displayed on a video image display device on an instructor side.

An operation site 100 illustrated on the left side of FIG. 1 and an instruction room 106 illustrated on the right side of FIG. 1 are located at a distance from each other.

In this scene example, an operator 101 is operating while receiving operation instructions on an operation subject 102 with an operation terminal 103 from an instructor 107. Hereinafter, the entire A in FIG. 1 is referred to as an operation assistance device.

A camera 103a for capturing a video image is provided on the back of the operation terminal 103 and capable of capturing the operation subject 102 and transmitting captured video image data to a remote place. Herein, when the operation terminal 103 is inclined, the camera 103a is inclined. The operation subject 102 captured in a captured video image is inclined with respect to an actual operation subject 102. Hereinafter, an inclination of the operation terminal 103 when capturing the captured video image is also referred to as a “capturing inclination”. An instruction device 108 installed in the instruction room 106 receives transmitted video image data and can display video image data (as additional screen information) on a video image display device 109.

The instructor 107 gives the operation instructions to the operator 101 on the video image display device 109 while seeing a video image 110 of the operation subject 102. At this time, a pointer or a marker 111 indicating an instruction position can be configured on a display screen through input by using a touch panel function, a mouse function, and the like. Configuration information data about a pointer and a marker is transmitted from the instruction device 108 to the operation terminal 103, so that the configuration information about the pointer and the marker can be shared with each other through a display unit of the operation terminal 103 and a screen of the video image display device 109.

Hereinafter, information displayed on the display screen, such as a pointer and a marker, is collectively referred to as marker information. A video image displayed on the display unit of the operation terminal 103 and the screen of the video image display device 109 by the marker information can be referred to as an instruction video image. The marker information can include text, a handwritten character, and a pattern.

A video image 104 of a projected operation subject 102 and a marker 105 based on the marker information configured on the video image display device 109 are superimposed on each other and displayed on the display unit of the operation terminal 103, and the operation instructions from the instruction room 106 can be visually determined.

Note that the marker information can be configured based on an input of the operator 101, and the instructor 107 and the operator 101 can share information including the marker with each other.

Remote Communication

FIG. 2 is a diagram illustrating one example of a remote communication system according to the present embodiment. The operation terminal 103 and the instruction device 108 are connected to each other through a public communication network (such as the Internet) NT, and can communicate with each other in accordance with a protocol such as TCP/IP and UDP.

The above-mentioned operation assistance device A further includes a management server 200 configured to collectively manage the marker information and connected to the same public communication network NT. Note that the operation terminal 103 can be connected to the public communication network NT through radio communication. In this case, the radio communication can be achieved by, for example, Wireless Fidelity (Wi-Fi; trade name) connection in accordance with international standards (IEEE 802.11) stipulated by Wi-Fi Alliance (the US industry organization).

A public communication network such as the Internet is exemplified for a communication network, but, for example, Local Area Network (LAN) used in companies can be used, and a configuration in which the public communication network and LAN are mixed can also be used.

Although FIG. 2 illustrates a configuration including the management server 200, it is also not problematic in a case where the operation terminal 103 and the instruction device 108 directly communicate with each other by incorporating all functions of the management server 200 into the operation terminal 103 or the instruction device 108.

A description of general voice communication processing and video communication processing, other than the additional screen information, that are used in a common videoconference system will be omitted without hindrance.

Example of Block Configuration (Operation Terminal)

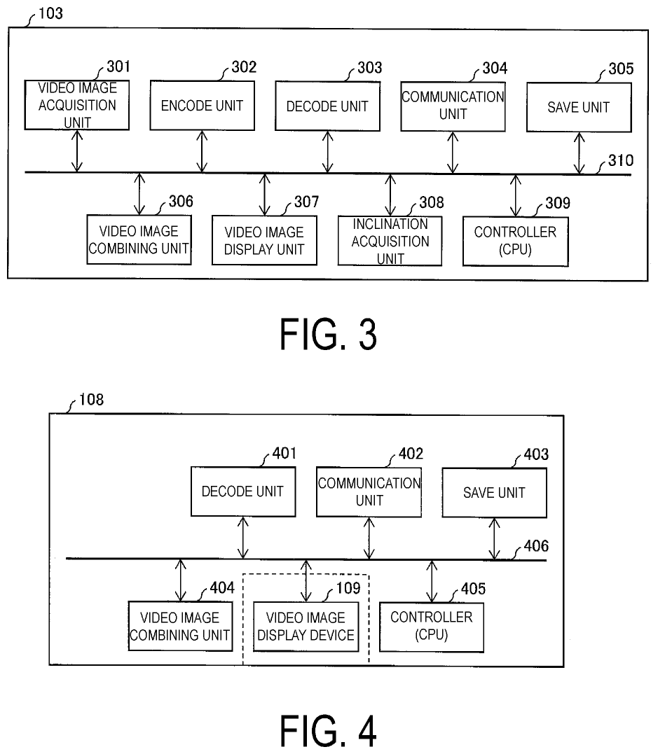

FIG. 3 is a functional block diagram illustrating one example of a configuration of the operation terminal 103 in the present embodiment.

The operation terminal 103 includes a video image acquisition unit 301 configured to acquire video image data, an encode unit 302 configured to code the video image data, a decode unit 303 configured to decode coded video image code data, a communication unit 304 configured to transmit and receive the coded video image code data and marker information data to and from the outside, a save unit 305 configured to save various pieces of data used for processing, a video image combining unit 306 configured to combine the video image data with marker information data superimposed on the video image data, a video image display unit 307 configured to display composite video image data, an inclination acquisition unit 308 configured to acquire inclination information about the operation terminal, a controller 309 configured to control the entire operation terminal 103, and a data bus 310 configured to exchange data among respective blocks.

The video image acquisition unit 301 includes an optical part for capturing a captured space as an image and an image pickup device such as a Complementary Metal Oxide Semiconductor (CMOS) and a Charge Coupled Device (CCD), and outputs video image data generated based on an electrical signal obtained by photoelectric conversion. The video image acquisition unit 301 may output captured information data as original data or as video image data that is image-processed (brightness imaging, noise removal, etc.) in advance so as to facilitate processing in a video image processing unit (not illustrated), or may have a configuration to output both data. In addition, the video image acquisition unit 301 may be configured to transmit a camera parameter, such as an aperture value and a focal distance at a time of capturing, to the save unit 305.

The encode unit 302 is configured with FPGA, ASIC, or a Graphics Processing Unit (GPU) and codes video image data acquired by the video image acquisition unit 301 such that the video image data has an amount of data smaller than that of the original data. There are various coding methods, and, for example, H.264 (International Standard Moving Image Compression Standards) suitable for coding moving images can be used.

The decode unit 303 is also configured with FPGA, ASIC, or GPU, similarly to the encode unit 302, performs processing that is reverse to coding of the video image data, and decodes the video image data into an original video image. There are also various decoding methods, but the decoding method needs to match the coding method, so herein an original signal is generated by H.264 decoding.

The communication unit 304 is configured with, for example, a digital signal processor (DSP), processes the coded video image code data and the marker information data, generates a communication packet, and transmits and receives the communication packet to and from the outside. Alternatively, the communication unit 304 may be configured to process by using a function of the controller 309 described later. The communication packet will be described later.

The save unit 305 is configured with a storage device such as a Random Access Memory (RAM) and a hard disk, for example, and in which the marker information data, decoded video image data, or the like is saved.

The video image combining unit 306 is configured with FPGA, ASIC, or a Graphics Processing Unit (GPU) and generates a video image including the video image data combined with the marker information data. The composition will be described later.

The video image display unit 307 is a device capable of displaying a video image based on a video image signal. For example, a liquid crystal display (LCD) can be used as the video image display unit 307. A liquid crystal display is a display device using liquid crystals, and is a device that changes a direction of liquid crystal molecules by applying a voltage to a thin film transistor formed in matrix between two glass plates and that increases and reduces transmittance of light to display an image. Coordinates of a touch on a screen with a finger can also be acquired by providing a touch sensor in the liquid crystal display.

The inclination acquisition unit 308 is configured with a triaxial acceleration sensor and an arithmetic unit (FPGA, ASIC, or DSP). The triaxial acceleration sensor is one type of a Micro Electro Mechanical Systems (MEMS) sensor capable of measuring acceleration of three directions in XYZ axes with one device. For example, a piezoresistance triaxial acceleration sensor can be used as the triaxial acceleration sensor, and is equal to a general-purpose device provided in common smartphones or tablets. A method for calculating an inclination of the operation terminal will be described later.

The controller 309 is configured with a Central Processing Unit (CPU) or the like, and commands and controls processing in each of functional blocks and controls input/output of data. The controller 309 also has a function of coding the marker information and a function of decoding marker information code data.

The data bus 310 is a bus configured to exchange data among respective units.

Note that the operation terminal 103 is preferably a portable terminal such as a smartphone, a tablet, and an eyeglass-type terminal that can be carried.

Example of Block Configuration (Instruction Device)

Next, FIG. 4 is a functional block diagram illustrating one example of a configuration of the instruction device 108 in the present embodiment.

The instruction device 108 has a subset configuration that is the above-mentioned configuration of the operation terminal 103 exclusive of the function of acquiring the video image data, the function of coding the video image data, the function of transmitting the video image code data, and the function of acquiring the inclination information. Note that FIG. 4 illustrates a configuration that incorporates the video image display device 109 of FIG. 1 to match the configuration of the operation terminal 103. A tablet device that houses the instruction device 108 and the video image display device 109 in one housing can also be used.

The instruction device 108 includes a decode unit 401 configured to decode coded video image code data, a communication unit 402 configured to receive video image code data or transmit and receive marker information data to and from the outside, a save unit 403 configured to save various pieces of data used for processing, a video image combining unit 404 configured to combine video image data with the marker information data, a controller 405 configured to control the entire instruction device 108, and a data bus 406 configured to exchange data among respective blocks.

The decode unit 401, the communication unit 402, the save unit 403, the video image combining unit 404, the video image display device 109, the controller 405, and the data bus 406 of the instruction device 108 have the same configuration and the same function as those of the decode unit 303, the communication unit 304, the save unit 305, the video image combining unit 306, the video image display unit 307, the controller 309, and the data bus 310 of the operation terminal 103, respectively, so that the description thereof will be omitted.

Marker Information

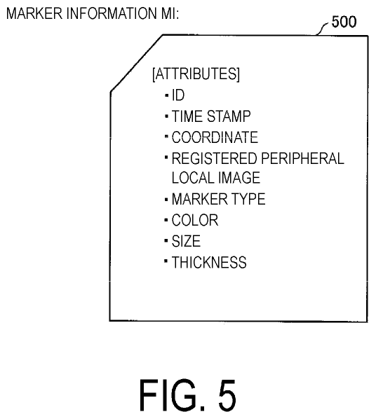

Marker information in the present embodiment will be described using FIG. 5.

As illustrated in FIG. 5, marker information 500 includes various attributes (ID, time stamp, coordinate, registered peripheral local image, marker type, color, size, thickness) and is an information group for controlling a display state such as a position and a shape. The attributes illustrated in FIG. 5 are examples. The marker information 500 may include a part of the attributes illustrated in FIG. 5 or include supplemental attribute information in addition to the attributes illustrated in FIG. 5. In other words, the attributes may be prescribed attributes that can be interpreted by the operation terminal 103 and the instruction device 108 that belong to the operation assistance device A and the management server 200.

Method for Generating Communication Signal

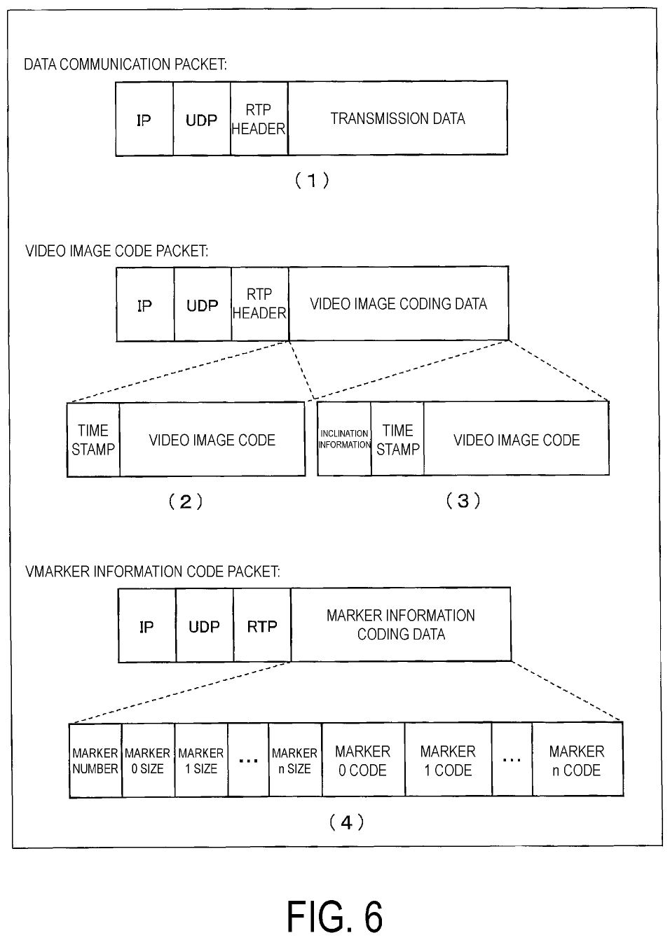

A method for generating various signals used in communication in the present embodiment will be described using FIG. 6.

First, a basic form of a data communication packet will be described (FIG. 6(1)).

The data communication packet includes an “IP”, a “UDP”, an “RTP header”, and “transmission data”. Herein, the “IP” indicates an address number for identifying equipment that transmits a packet. The “User Datagram Protocol (UDP)” indicates a protocol designed for real-time transmission that does not need to establish connection. The “RTP header (Real-time Transport Protocol)” indicates a protocol for streaming transmission. The “transmission data” indicates data to be actually transmitted.

Hereinafter, all packets used in communication have this format as a basis.

Next, an example of a video image code packet is illustrated in FIGS. 6(2) and 6(3). Video image coding data corresponding to transmission data is data coding one frame video image and data including a “time stamp” and a “video image code” thereof combined together. Note that it is assumed that “inclination information” of the operation terminal is added as a part of the video image coding data as illustrated in FIG. 6(3). Details of the inclination information will be described later.

Next, an example of a marker information code packet is illustrated in FIG. 6(4). Marker information coding data corresponding to transmission data is data including a plurality of pieces of marker information, and includes a “marker number” indicating the number of markers included in a packet, a “marker size” indicating a code size of an n-th marker from a 0-th marker, and a “marker code” in which each piece of marker information is coded. Note that the marker code needs to be used as digital information (decoded data needs to completely match data before coding), so that the marker code needs to be coded by reversible coding processing. For example, a ZIP method (one of reversible coding methods) can be used as reversible coding. However, the marker information has an amount of information smaller than that of a video image, so that a method for communication by using the original signal as it is without coding may be used. In this case, a marker has a fixed data size, so that the marker size (0 to n-th) can also be omitted in contrast to FIG. 6(4).

Note that although an example in which the video image code and the marker code are different packets in the communication packet is described, a packet including the video image code and the marker code combined together can be defined and also be used as the communication packet.

Method for Combining Video Image

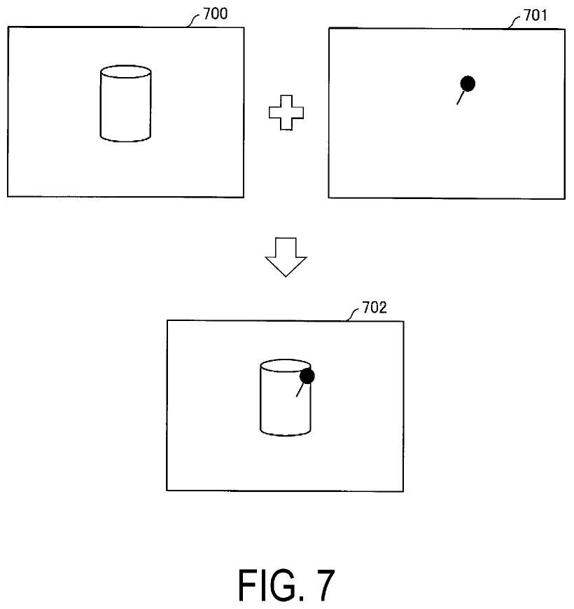

A method for combining a video image in the present embodiment will be described using FIG. 7.

As illustrated in FIG. 7, the video image combining unit 306 or the video image combining unit 404 combines a marker 701 generated according to attributes (a position and a shape) included in the above-mentioned marker information 500 with an input video image 700, and generates a composite video image 702. Note that a generated marker may be a vector image based on a group of straight lines and curved lines defined by a mathematical expression referred to as a vector, or may be a bitmapped image (also referred to as a raster image) in which positional information that is a square pixel has color information. In composition of a bitmapped image, a pixel value of a background video image in a composite position may be simply replaced by a pixel value of a marker, a pixel value of a background video image may be used for a portion in a transparent color with a particular color serving as the transparent color, or alpha blending processing may be performed by a prescribed composite ratio. Any of the methods are very general techniques.

Method for Acquiring Inclination Information

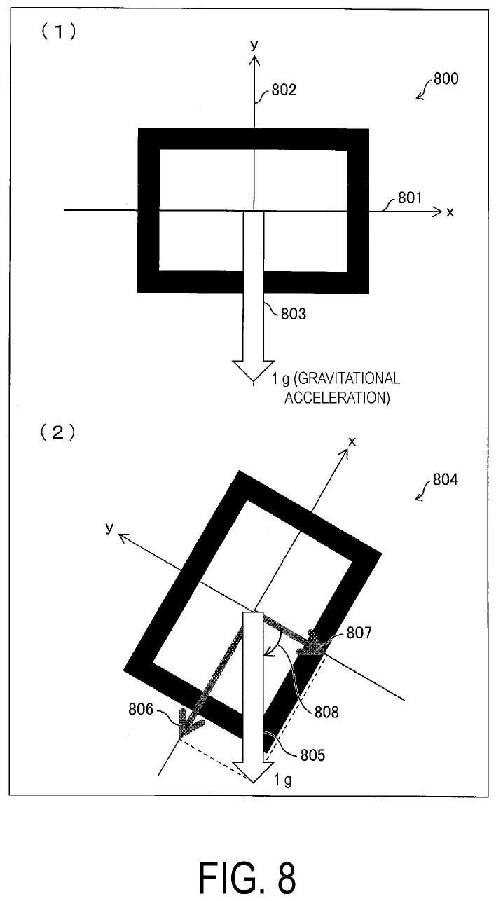

A method for acquiring the inclination information about the operation terminal in the present embodiment will be described using FIG. 8.

First, the inclination acquisition unit 308 sets a rectangular coordinate system including, as coordinate axes of the operation terminal 103, an x-axis 801 having a rightward direction of a long-side direction as a positive direction, a y-axis 802 having an upward direction of a short-side direction vertical to the x-axis as a positive direction, and a z-axis (not illustrated) having a direction toward a screen and vertical to both of the x-axis and the y-axis as a positive direction. Hereinafter, the coordinate system is referred to as an operation terminal coordinate system.

As mentioned above, the operation terminal 103 includes a triaxial acceleration sensor and can measure acceleration toward each of the axes in the operation terminal coordinate system.

For example, as illustrated in FIG. 8(1), when the operation terminal 103 is standing still vertically to a ground surface (800), one gravitational acceleration (described as 1 g) is generated in a negative direction of the y-axis (803). On the other hand, the example of FIG. 8(2) illustrates a state where the operation terminal 103 is inclined (804). Gravitational acceleration 805 is generated toward the ground, and acceleration measured by the acceleration sensor of the operation terminal 103 is distributed to acceleration 806 generated in a negative direction of the x-axis and acceleration 807 generated in the negative direction of the y-axis. On the assumption herein that an inclination angle of the operation terminal 103 is θ (in units of radians) and a direction indicated by 808 in FIG. 8 is a positive direction of rotation, the inclination acquisition unit 308 can calculate the inclination angle θ of the operation terminal 103 by (Equation 1) below.

$$\begin{matrix}[ Equation 1 ] & \\ θ = {tan}^{- 1} ( \frac{{A}_{x , OUT}}{{A}_{y , OUT}} ) & ( Equation 1 )\end{matrix}$$

Herein, A_{x, out} and A_{y, out} respectively indicate gravitational acceleration generated in the x-axis and gravitational acceleration generated in the y-axis, and tan⁻¹ indicates an inverse function of tan.

In this way, the inclination acquisition unit 308 can calculate an inclination of the operation terminal 103 based on distribution of the gravitational acceleration to the x-axis and the y-axis. Acceleration due to movement of the operation terminal 103, except for the gravitational acceleration, is actually added, but acceleration due to movement of the operation terminal 103 can be removed by, for example, filtering an observed value of the acceleration sensor with a low-pass filter to cut an acceleration component due to sudden momentary movement. A general technique can be used for the low-pass filter.

Example of Block Configuration (Management Server)

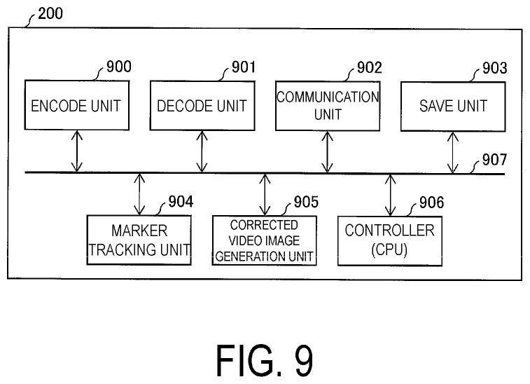

FIG. 9 is a functional block diagram illustrating one example of a configuration of the management server 200 in the present embodiment.

The management server 200 includes an encode unit 900 configured to code video image data, a decode unit 901 configured to decode coded video image code data, a communication unit 902 configured to transmit and receive the coded video image code data, inclination information about the operation terminal acquired by the inclination acquisition unit 308, marker information data, and the like, a save unit 903 configured to save various pieces of data used for processing, a marker tracking unit 904 configured to track a marker position based on input video image data and update the marker position, a corrected video image generation unit 905 configured to correct the video image data to change a displayed inclination angle of a video image based on the inclination information about the operation terminal 103, a controller 906 configured to control the entire management server 200, and a data bus 907 configured to exchange data among respective blocks.

Herein, the encode unit 900, the decode unit 901, the communication unit 902, the save unit 903, the controller 906, and the data bus 907 have the same configuration and the same function as those of the above-mentioned blocks provided with same names, so that the description thereof will be omitted.

The marker tracking unit 904 is configured with FPGA, ASIC, or a Graphics Processing Unit (GPU) and updates managed positional information about a marker by using video image data in a current frame and video image data in a previous frame. The marker tracking processing will be described later.

The corrected video image generation unit 905 is configured with FPGA, ASIC, or a Graphics Processing Unit (GPU) and performs processing of correcting an input video image based on the inclination information about the operation terminal 103. Contents the video image correction processing will be described later.

Marker Tracking Processing

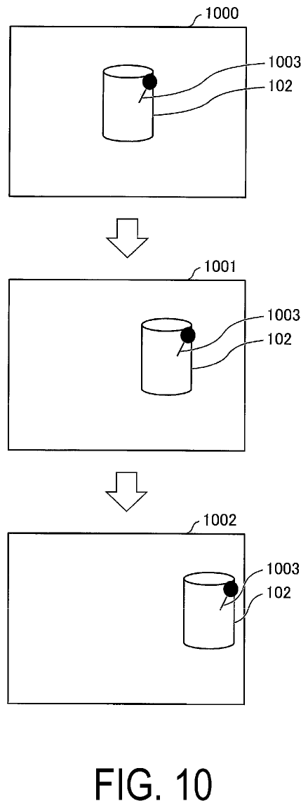

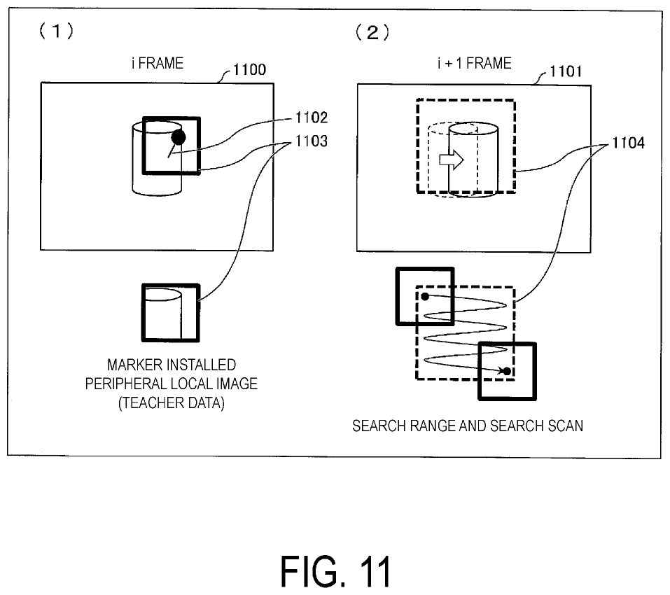

The marker tracking processing in the present embodiment will be described using FIGS. 10 and 11.

First, an image of marker tracking will be described using FIG. 10. As mentioned above, a marker configured by an operator or an instructor can change a position thereof while tracking a place corresponding to a configured original position according to movement of a captured video image.

For example, FIG. 10 illustrates a situation where the operation subject 102 on which a marker is configured is projected at the center of the screen (1000) and is gradually moving to the right end of the screen (1001 and 1002). At this time, the operation terminal 103 is actually moving toward the left. The marker 1003 configured by the operator or the instructor is also gradually moving to the right end by the marker tracking processing. This is an outline of the marker tracking.

Next, specific contents of the marker tracking processing will be described using FIG. 11.

The marker tracking unit 904 sets a position of a marker 1102 in an i frame 1100 configured by the operator or the user as Pᵢ=(xᵢ, yᵢ) and sets a position of a marker in an i+1 frame 1101 as Pᵢ₊₁=(xᵢ₊₁, yᵢ₊₁). The marker tracking unit 904 successively calculates a position thereof in the successive frames. The processing is the marker tracking processing. In other words, the marker tracking unit 904 can obtain a marker position in a current frame by updating a marker position from the time of configuration to the current frame.

In the present embodiment, the marker tracking unit 904 calculates a marker position by using template matching of image processing. The template matching is a method for extracting a region, similar to a local region image, as a teacher (hereinafter referred to as teacher data) from an image by using local block matching.

Herein, the marker tracking unit 904 registers a local region (for example, a 15×15 region) of the marker position configured in the i frame 1100 as teacher data T1103. A mathematical expression expressing T is (Equation 2) below. Note that the teacher data T is one attribute of marker information as a registered peripheral local image included in the above-mentioned marker information.

[Equation 2]

T={Iᵢ(x,y)|xᵢ−7≤x≤xᵢ+7,yᵢ−7≤y≤yᵢ+7} (Equation 2)

Herein, Iᵢ(x, y) is a pixel value in coordinates (x, y) of the i frame image.

When the marker tracking unit 904 acquires teacher data as in (Equation 2) during marker configuration, the marker tracking unit 904 searches an image region similar to the teacher data from a next frame. A search range may be the entire image, but a search range can be limited in successive video image frames based on a rule of thumb that movement of a corresponding pixel is not that great. It is assumed in the present example that, for example, the search range is limited to a range of 51×51 pixels with a marker position in a previous frame as the center (1104).

Herein, P as a search range can be expressed as in (Equation 3) below.

[Equation 3]

Pᵢ₊₁={(x,y)|xᵢ−25≤x≤xᵢ+25,yᵢ−25≤y≤yᵢ+25} (Equation 3)

Various methods serve as indicators indicating a degree of similarity used in the template matching and any method can be used. Herein, Sum of Absolute Difference (SAD) is used. An equation of the template matching using the SAD is (Equation 4) below.

$$\begin{matrix} [ Equation 4 ] & \\ {argmin}_{( x , y ) ∈ {P}_{i + 1}} ( {\sum }_{s = 7}^{7} {\sum }_{t = - 7}^{7} ( \vert {I}_{i + 1} ( x + s , y + t ) - T ( s + 7 , t + 7 ) \vert ) ) & ( Equation 4 )\end{matrix}$$

Herein, argmin(·) is a function that calculates a parameter under argmin minimizing the inside of the parenthesis.

As described above, a pixel position that is the most similar to the teacher data can be obtained in a prescribed search range, and this position is updated as a marker information in the i+1 frame.

The marker tracking unit 904 can calculate a new marker position while tracking an originally configured place by successively performing the above-described processing.

Video Image Correction Processing Method Based on Inclination Information

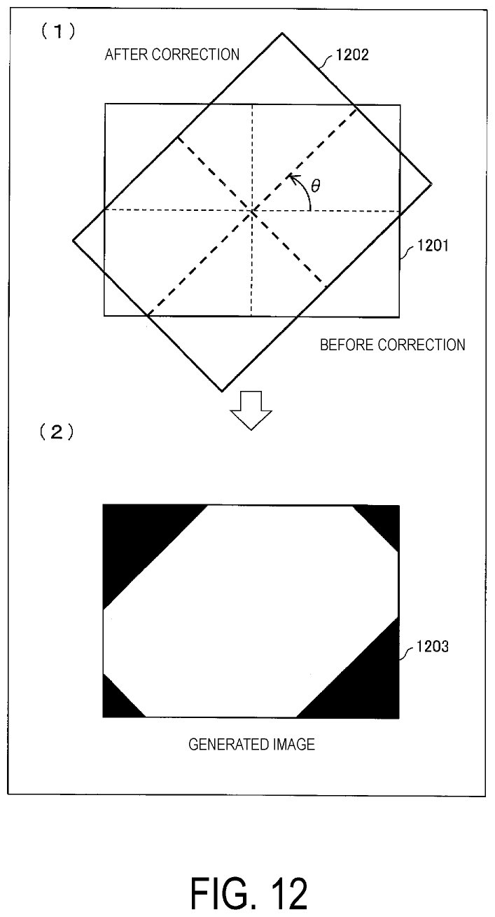

A video image correction processing method based on inclination information about the operation terminal 103 in the present embodiment will be described using FIG. 12.

A video image before correction is the same video image as the captured video image and corresponds to 1201 in FIG. 12. The corrected video image generation unit 905 can match, by performing a correction opposite to the above-mentioned inclination of the operation terminal 103 on this video image, an inclination of the operation terminal 103 with which the operator on an operator side captures a video image with an inclination of a video image displayed on the video image display device 109 on an instructor side (1202). For example, a perpendicular direction of the operation terminal 103 can be substantially matched with a perpendicular direction of the captured video image of a subject received by the instruction device 108. A state where they are substantially matched with each other indicates that a perpendicular direction of the operation terminal 103 is along a perpendicular direction of the captured video image of the subject received by the instruction device 108. The state may also be expressed to indicate a state where the operator and the user have the same sense of up, down, right, and left directions. The state where they are substantially matched with each other is preferably a state where, for example, a relative deviation in each of the perpendicular directions is within +5°. Specifically, the state is achieved by performing processing below on a video image.

$$\begin{matrix} [ Equation 5 ] & \\ {I}_{dst} ( x , y ) = {I}_{s r c} ( \begin{matrix}( x - c x ) \times cos θ - ( y - c y ) \times sin 0 + cx , \\ ( x - cx ) \times sin θ + ( y - cy ) \times cos 0 + cy\end{matrix} ) & ( Equation 5 )\end{matrix}$$

Herein, I_{dst} is a pixel value at a point (x, y) of a generated image (1203) after correction, and Iₛᵣₑ is a pixel value at a point (x, y) of an image before correction. Further, (cx, cy) is the center of an image, and θ is the above-mentioned inclination information about the operation terminal 103.

Flowchart

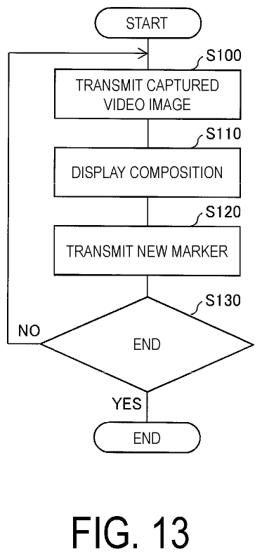

Next, a processing procedure in the present embodiment will be described using FIGS. 13 to 16.

First, a rough processing procedure in the operation terminal 103 will be described using FIG. 13.

In the operation terminal 103, the encode unit 302 codes the video image data, and the communication unit 304 transmits the video image code data to the outside (Step S100). The decode unit 303 decodes the video image code data transmitted from the outside, the controller 309 decodes the marker information code data transmitted from the outside, and the video image display unit 307 displays a composite video image on a screen (Step S110). The controller 309 codes marker information newly generated by a touch on the screen by the user and transmits the marker information to the outside (Step S120), and then determines completion processing (Step S130).

A processing procedure in the instruction device 108 is the processing procedure in the operation terminal 103 except for Step S100. In other words, in the instruction device 108, the decode unit 401 decodes the video image code data transmitted from the outside, and the controller 405 decodes the marker information code data. Furthermore, the video image display unit 109 displays the composite video image on a screen (Step S110). The controller 405 codes the marker information newly generated by the touch on the screen by the user, and the communication unit 402 transmits the marker information to the outside (Step S120). Then, the completion processing is determined (Step S130).

Hereinafter, processing steps of the operation terminal 103 will be described.

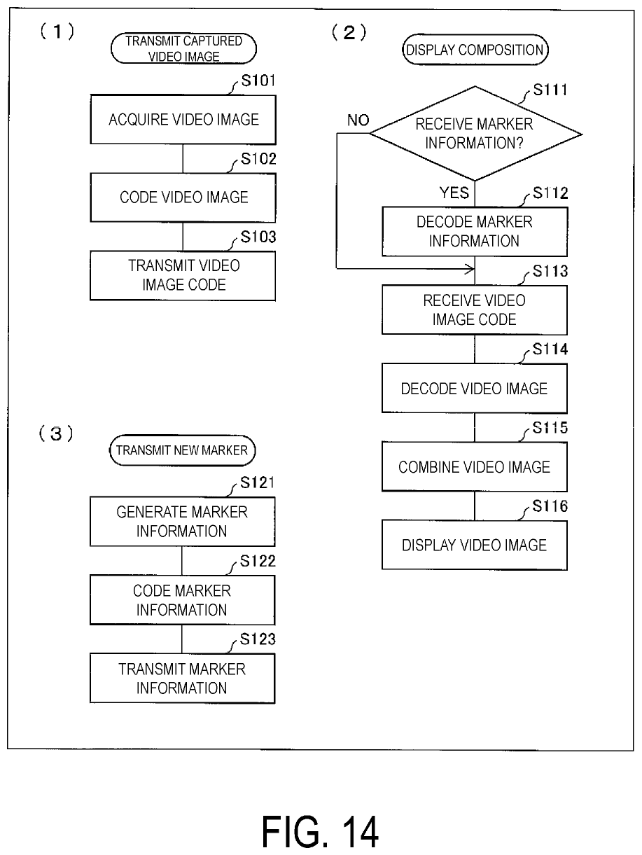

Next, details of each processing step illustrated in FIG. 13 will be described using FIG. 14.

In Step S100, the video image acquisition unit 301 acquires video image data in a current frame of captured data captured by a capturing camera (Step S101), and the encode unit 302 codes the video image data (Step S102). Subsequently, the communication unit 304 inputs the coded video image code data, processes the video image code data into a communicable packet, and then outputs the packet to the outside (Step S103). Note that the outside may be the management server 200, and the packet may be transmitted to the management server 200.

In Step S110, the communication unit 304 waits for reception of a marker information code packet (Step S111). When the communication unit 304 receives the packet, the controller 309 decodes marker information data (Step S112) and outputs a result of decoding to the video image combining unit 306 and the save unit 305. Furthermore, when the communication unit 304 receives a video image code packet from the outside (Step S113), the communication unit 304 outputs a video image code to the decode unit 303. The decode unit 303 decodes the video image code data into an original signal (S114) and outputs decoded video image signal data to the video image combining unit 306. When the video image combining unit 306 receives the marker information data and the video image signal data, the video image combining unit 306 performs video image combining processing (Step S115). The video image display unit 307 displays the composite video image on the screen (Step S116).

In Step S120, the controller 309 generates new marker information data by a touch on the screen connected to the video image display unit 307 (Step S121). The controller 309 codes generated marker information data and transmits the marker information data to the communication unit 304 (Step S122). The communication unit 304 generates a marker information code packet and transmits the marker information code packet to the outside (Step S123). The outside may be the management server 200, and the packet may be transmitted to the management server 200.

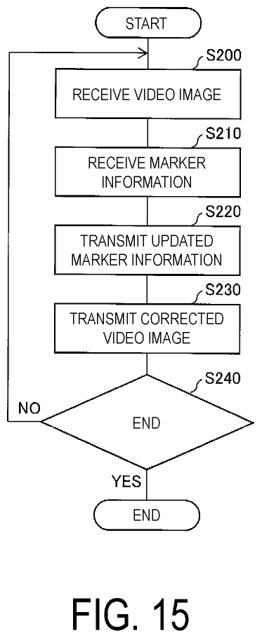

Next, a rough processing procedure of an operation assistance method in the management server 200 will be described using FIG. 15.

In the management server 200, the decode unit 901 decodes the received video image code data and generates original video image data (Step S200). The save unit 903 decodes received marker information data and holds the marker information data as a management target (Step S210). The communication unit 902 transmits marker information data updated based on a decoded video image signal (Step S220), and outputs a corrected video image generated based on inclination information about the operation terminal 103 to the outside (Step S230). The controller 906 determines completion processing (Step S240).

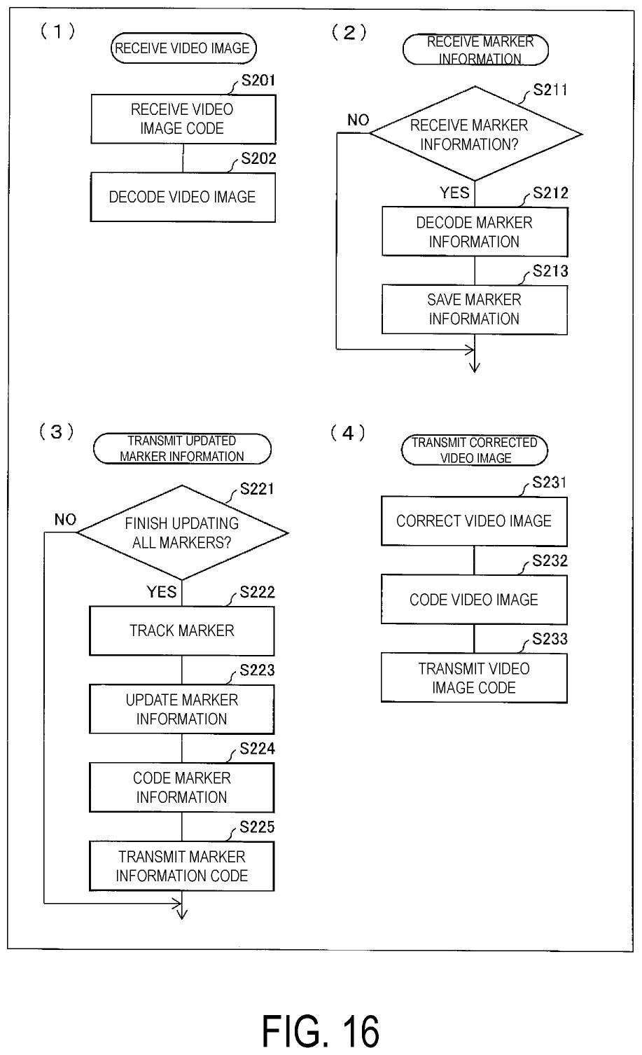

Next, details of each processing step illustrated in FIG. 15 will be described using FIG. 16.

In Step S200, the communication unit 902 receives a video image code packet (Step S201), and outputs video image code data to the decode unit 901 and also outputs inclination information about the operation terminal 103 to the corrected video image generation unit 905. The decode unit 901 decodes the received video image code data into original video image signal data (Step S202), and outputs the video image signal data to the save unit 903 and the corrected video image generation unit 905.

In Step S210, when the communication unit 902 receives a marker information code packet (Step S211), the controller 906 decodes marker information data and extracts original marker information data (Step S212). The controller 906 saves the marker information in the save unit 903 (Step S213).

In Step S220, the controller 906 performs the following processing on all marker information data saved in the save unit 903 (Step S221). The marker tracking unit 904 performs marker tracking processing on each piece of marker information extracted from the save unit 903 (Step S222). The marker tracking unit 904 replaces marker information managed in the save unit 903 with updated marker information data (Step S223) and also outputs the marker information data to the controller 906. The controller 906 codes the received marker information data (Step S224). The communication unit 902 processes the coded marker information data into a marker information code packet, and outputs the marker information code packet to the outside (Step S225). The outside may be the operation terminal 103 and the instruction device 108, and the packet may be transmitted to the operation terminal 103 and the instruction device 108.

In Step S230, when the corrected video image generation unit 905 receives video image data in a current frame decoded by the decode unit 901, video image data in a previous frame saved in the save unit 903, and inclination information about the operation terminal 103, the corrected video image generation unit 905 performs the above-mentioned video image correction processing (Step S231), and outputs corrected video image data generated as a result of the processing to the encode unit 900. When the encode unit 900 receives the corrected video image data from the corrected video image generation unit 905, the encode unit 900 performs coding processing (Step S232), and outputs video image code data of the corrected video image data generated as the result of the processing to the communication unit 902. When the communication unit 902 receives the video image code data of the corrected video image data, the communication unit 902 processes the video image code data to be communicable, generates a video image code packet, and transmits the video image code packet to the outside (Step S233). The outside may be the instruction device 108, and the packet may be transmitted to the instruction device 108. At the same time, the communication unit 902 transmits video image code data before correction as it is to the operation terminal 103, for example, of the outside. In this way, captured video image data is transmitted as it is to the operation terminal 103, and video image data after correction is transmitted to the instruction device 108.

According to the configuration above, a method for assisting a remote operation, while an inclination of the operation terminal with which the operator on the operator side captures a video image is matched with an inclination of a video image displayed on the video image display device 109 on an instructor side, can be provided.

Note that the instruction device 108 may have all the functions of the management server 200 as mentioned above. In other words, the disclosure also includes an instruction device further including the communication unit configured to receive a captured video image from the operation terminal 103 and inclination information about the operation terminal 103 and the corrected video image generation unit configured to correct video image data to change a displayed inclination angle of a video image based on the inclination information about the operation terminal 103.

### Embodiment 2

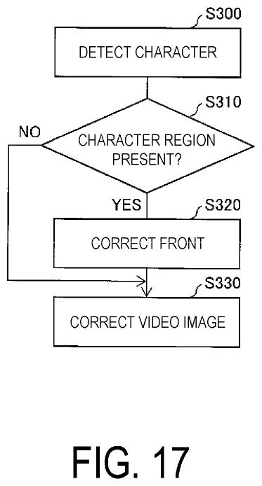

Another embodiment of the disclosure is as follows with description based on FIGS. 17 to 20. Note that, for convenience of explanation, components illustrated in respective embodiments are designated by the same reference numerals as those having the same function, and the descriptions of these components will be omitted.

In the present embodiment, a method for changing a captured direction of a video image based on an analysis result of the captured video image and displaying the video image on a screen on an instructor side will be described.

In Embodiment 1 described above, an inclination of the operation terminal 103 with which the operator on the operator side captures a video image is substantially matched with an inclination of a video image displayed on the video image display device 109 on the instructor side. In the present embodiment, an inclination during capturing is further corrected according to contents captured in a captured subject, and a video image can thus be displayed. Specifically, when a plane including information in which a character or the like can be read (hereinafter also referred to as an operation plane) is captured in a captured video image, a video image to be displayed is transformed into such a video image that an instructor acquires an operation plane from the front, and the video image is displayed on an instructor side.

The present embodiment and Embodiment 1 may have the same configuration. A difference between them is only processing contents in the corrected video image generation unit 905 of the management server 200. Hereinafter, a difference in processing of the corrected video image generation unit 905 will be described.

Flowchart of Corrected Video Image Generation

FIG. 17 is a procedure of corrected video image generating processing in the present embodiment.

The corrected video image generation unit 905 of the management server 200 determines whether a character region is present in a video image (Step S300 and Step S310). When the character region is present in the video image, front correction processing is performed (Step S320). Subsequently, the video image correction processing described in Embodiment 1 is performed (Step S330). Note that the video image correction processing may be the same as the video image correction processing based on inclination information (Step S231 in FIG. 16(4)). Character detection and front correction will be described later. Note that the video image correction processing (Step S330) may be canceled by configuration from the outside.

Character Detection Processing

Determination of whether a character region is present in a video image is sufficient for character detection in the present embodiment, and recognition of a character is not needed. Various APIs determine the presence or absence of a character region in such a manner. For example, the determination can be achieved by using a character recognition unit by Optical Character Recognition/Reader (OCR) and a function of Open Source Computer Vision Library (Open CV, library for open source computer vision) being a general-purpose API of computer vision, and Scene Text Detection (http://docs.opencv.org/3.0-beta/units/text/doc/erfilter.html) can also be used.

Front Correction Processing

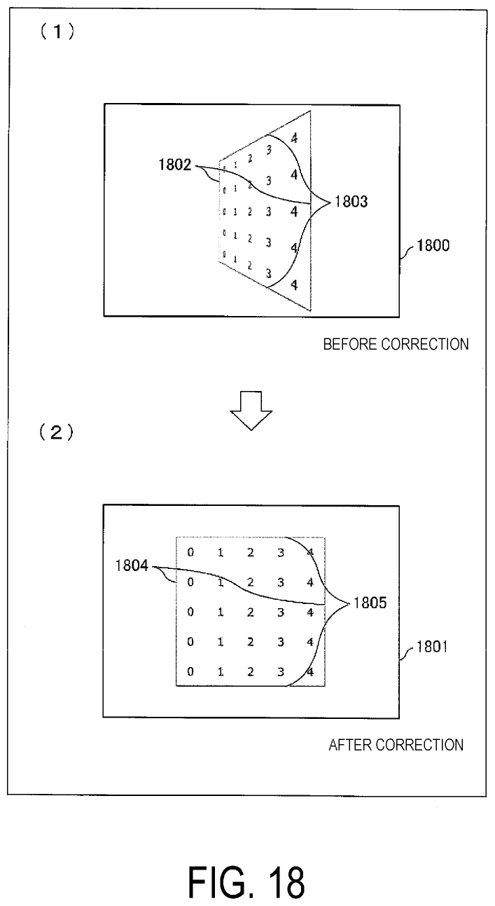

Front correction processing in the present embodiment will be described using FIGS. 18 to 20.

The front correction processing in the corrected video image generation unit 905 is achieved by projective transformation processing by a homography matrix. The projective transformation processing is processing of transforming a plane into another plane, and transforms a video image 1800 captured from a diagonal direction as illustrated in FIG. 18 into such a transformation 1801 as to be seen from the front.

First, a mathematical expression of the projective transformation processing by a homography matrix H* in the corrected video image generation unit 905 is expressed by (Equation 6) below.

$$\begin{matrix}[ Equation 6 ] & \\ ( \begin{matrix}{m}^{′} \\ {y}^{′} \\ 1\end{matrix} ) = H * ( \begin{matrix}m \\ n \\ 1\end{matrix} ) & ( Equation 6 )\end{matrix}$$

Herein, coordinates (m, n) and coordinates (m′, n′) respectively indicate coordinates before transformation and coordinates after transformation. H* in (Equation 6) is a 3×3 matrix, and each element can be expressed as in (Equation 7) below.

$$\begin{matrix}[ Equation 7 ] & \\ H * = ( \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ) & ( Equation 7 )\end{matrix}$$

Subsequently, a method for calculating this homography matrix will be described. (Equation 7) has nine elements, but (Equation 7) substantially has eight types of variables in a case where h₃₃ is controlled to be one. Two equations of m and n are obtained according to a correspondence of pixels before and after transformation and can thus be obtained by the least squares method in a case where four or more correspondences are clear. An equation provided to the least squares method is as (Equation 8) below.

$$\begin{matrix} [ Equation 8 ] & \\ {argmin}_{{h}_{11} , … , {h}_{33}} ( {\sum }_{l = 1 , … , n} {( {m}^{′} - \frac{{h}_{11} m + {h}_{12} n + {h}_{13}}{{h}_{31} m + {h}_{32} n + {h}_{33}} )}^{2} + {( {n}^{′} - \frac{{h}_{21} m + {h}_{22} n + {h}_{23}}{{h}_{31} m + {h}_{32} n + {h}_{\underline{3} 3}} )}^{2} ) & ( Equation 8 )\end{matrix}$$

Herein, argmin(·) is a function that calculates a parameter under argmin minimizing the inside of the parenthesis.

When there are four or more groups of combinations of coordinates before and after transformation, the above-mentioned homography matrix can be calculated, and the projective transformation processing on the entire image can be achieved by using (Equation 6).

Next, a method for obtaining a corresponding point before and after correction will be described.

Prior to that, the corrected video image generation unit 905 achieves transformation into such a video image as to be captured from the front by performing correction such that straight lines facing each other and having greater than or equal to a prescribed length present in an image are parallel to each other. This is based on a rule of thumb that a readable character is often described in a rectangular region in general. As illustrated in FIG. 18, corresponding sides 1802 or sides 1803 are transformed into sides 1804 or sides 1805, respectively, so as to be parallel to each other.

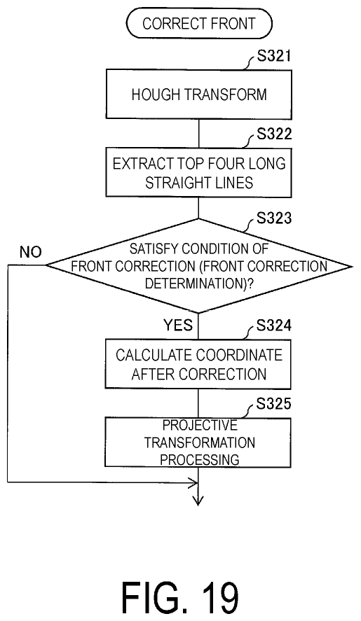

FIG. 19 illustrates a processing procedure of front correction.

First, the corrected video image generation unit 905 detects a straight line present in an image by the Hough transform of image processing (Step S321). Hough transform processing is a general technique for detecting a straight line in an image and is a technique for obtaining a straight line by defining the straight line by a distance r (r≥0) from the origin to the straight line and an inclination angle θ (0≤θ≤2Π) and by plotting (voting) an edge in the image on coordinates with the straight line as a coordinate axis. An equation of a straight line in the Hough transform is as (Equation 9) below.

[Equation 9]

r(θ)=x·cos θ+y·sin θ (Equation 9)

Next, the corrected video image generation unit 905 extracts up to top four straight lines from straight lines having a great number of votes obtained by the Hough transform (Step S322). In the Hough transform, a longer straight line has a greater number of votes. An extracted straight line is expressed by (rᵢ, θᵢ)=[i=0, . . . , 3].

Then, the corrected video image generation unit 905 determines whether the extracted straight line can be a target of the front correction processing (Step S323).

The determination of whether the extracted straight line can be a target of the front correction processing (hereinafter referred to as front correction determination) is performed as follows.

A first condition of the front correction determination in the corrected video image generation unit 905 is that a straight line is greater than or equal to a prescribed length. In other words, it is determined that the number of votes V(i) [i=0, . . . , 3] mentioned above is greater than or equal to a prescribed number. Herein, for example, a threshold value thereof is configured as 20.

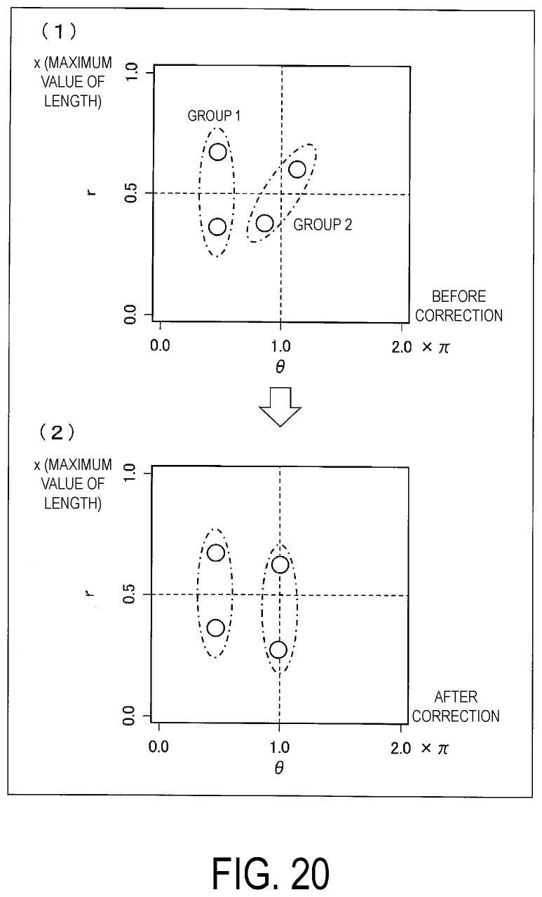

A second condition of the front correction determination in the corrected video image generation unit 905 will be described using FIG. 20. FIG. 20 is a diagram schematically illustrating four extracted straight lines being plotted by the above-mentioned Hough transform processing.

The corrected video image generation unit 905 selects two straight lines having similar inclination angles from (rᵢ, θᵢ)=[i=0, . . . , 3] indicating the four extracted straight lines, and classifies them into two groups as illustrated in FIG. 20(1). At this time, the two straight lines included in each of the groups are straight lines facing each other. The second condition is that a difference in inclination angle of straight lines included in a group 1 and a group 2 is defined to be greater than or equal to a prescribed value. Herein, for example, a threshold value thereof is configured as Π/4.

When the two conditions described above are satisfied, the corrected video image generation unit 905 performs correction processing below.

Subsequently, as illustrated in FIG. 20(2), the corrected video image generation unit 905 transforms coordinates after correction in coordinate axes of the Hough transform such that inclination angles of the straight lines included in each of the groups match each other, and calculates the coordinates. As an inclination angle after correction, any of interior, maximum, and minimum inclination angles of a straight line included in a group may be selected, or an average value or a median value may be selected. The corrected video image generation unit 905 transforms coordinates to the coordinates as illustrated in FIG. 20(2), obtains straight lines after the correction, and can obtain, together, corresponding coordinates before and after correction (Step S324).

Finally, the corrected video image generation unit 905 performs the above-mentioned projective transformation processing on the entire image and acquires a front correction image generated by correcting a video image such that an operation plane included in a subject is the front as illustrated in 1801 of FIG. 18 (Step S325).

Note that although the method of the front correction by the image processing is illustrated in the present embodiment, any method for obtaining a video image that appears to be captured from the front can be used. For example, a range finder for obtaining a depth map (map data two-dimensionally indicating a distance value to an object) may be provided on the camera 103a side of the operation terminal to directly obtain an inclination of the operation terminal with respect to a surface of an object, and a parameter of projective transformation may be calculated from acquired inclination information.

According to the configuration above, a method can be provided, based on an analysis result of a captured video image, for assisting a remote operation while a video image is corrected such that a captured direction of a video image is the front and the video image is displayed on a screen on an instructor side.

### Embodiment 3

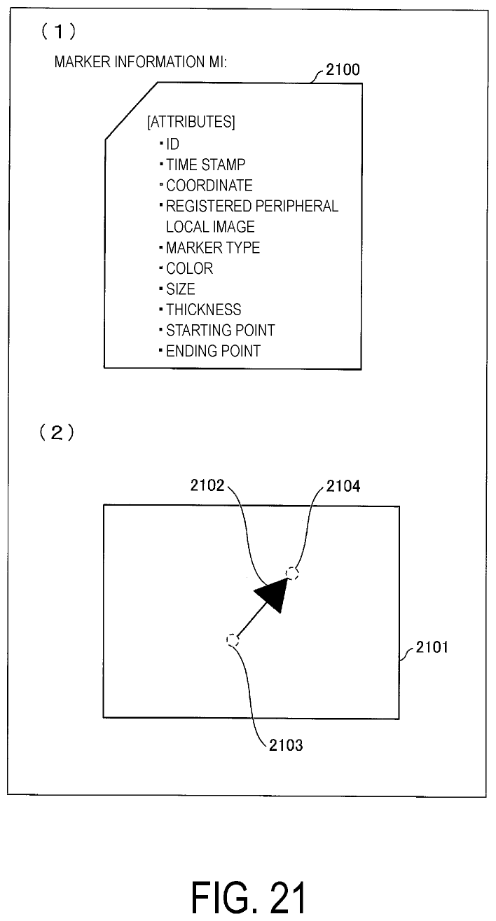

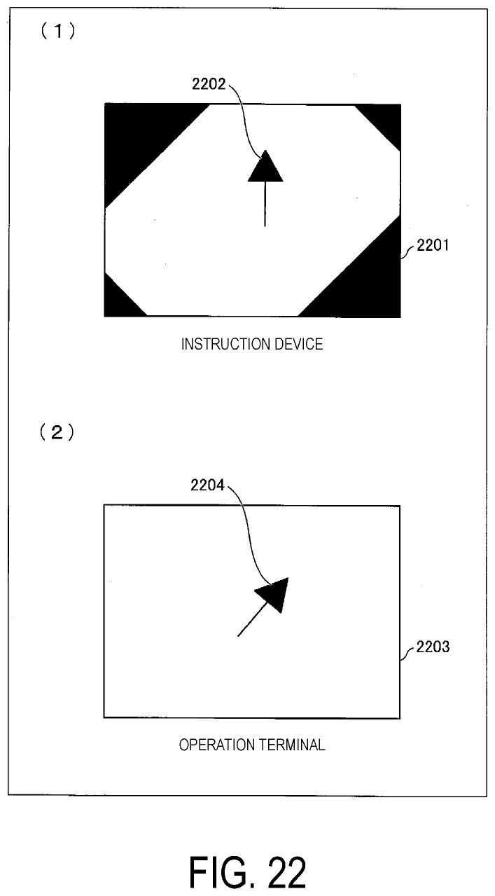

Another embodiment of the disclosure is as follows with description based on FIGS. 21 to 22. Note that, for convenience of explanation, components illustrated in respective embodiments are designated by the same reference numerals as those having the same function, and the descriptions of these components will be omitted.

In the present embodiment, a method for rotating marker information provided to the instruction device 108 by using inclination information acquired by the inclination acquisition unit 308 mentioned above and displaying the marker information on the operation terminal 103 will be described.

In Embodiment 1 and Embodiment 2 above, the video image data is combined with the marker information data received from the instruction device 108 in the video image combining unit 306. The marker information data to be combined is generated by using the video image 1203 after correction displayed on the instruction device 108 and is used as it is. Thus, when a direction is instructed with the marker information data, an instructed direction displayed on the operation terminal 103 is different from an instructed direction intended by an instructor, and the problem thus arises that operation instructions cannot be appropriately provided.

In the present embodiment, a method for rotating marker information by using inclination information acquired by the inclination acquisition unit 308 and displaying the marker information is used.

Only a difference between the embodiments 1 and 2 and the present embodiment will be described below.

Marker Information

Marker information in the present embodiment will be described using FIG. 21.

Marker information 2100 includes starting point information and ending point information in addition to the elements included in marker information 400.

The starting point information and the ending point information are coordinates in a video image on the instruction device 108. It is assumed herein that coordinates of a starting point 2103 of a marker 2102 on a screen 2101 of the instruction device 108 are (xs, ys) and coordinates of an ending point 2104 are (xg, yg).

Method for Rotating Marker Information

Next, a method for rotating marker information by using inclination information, namely, a method for changing a displayed inclination angle with respect to an instruction video image will be described using FIG. 22.

A marker 2202 configured on a screen 2201 of the instruction device 108 is transmitted to the corrected video image generation unit 905 of the management server. The corrected video image generation unit 905 updates starting point information and ending point information about the marker 2202 by using inclination information θ acquired by the inclination acquisition unit 308 (Equation 10 and Equation 11).

$$\begin{matrix} [ Equation 10 ] & \\ ( {x}_{s}^{′} , {y}_{s}^{′} ) = ( \begin{matrix}( {x}_{s} - cx ) \times cos θ - ( {y}_{s} - cy ) \times sin θ + cx , \\ - ( {x}_{s} - cx ) \times sin θ + ( {y}_{s} - cy ) \times cos θ + cy\end{matrix} ) & ( Equation 10 ) \\ [ Equation 11 ] & \\ ( {x}_{g}^{′} , {y}_{g}^{′} ) = ( \begin{matrix}( {x}_{g} - cx ) \times cos θ + ( {y}_{g} - cy ) \times sin θ + cx , \\ - ( {x}_{g} - cx ) \times sin θ + ( {y}_{g} - cy ) \times cos θ + cy\end{matrix} ) & ( Equation 11 )\end{matrix}$$

A marker 2204 having a starting point and an ending point updated is displayed on a screen 2203 of the operation terminal.

As described above, a method for rotating marker information provided to the instruction device 108 by using inclination information acquired by the inclination acquisition unit 308 and displaying the marker information on the operation terminal 103 can be provided.

### Embodiment 4

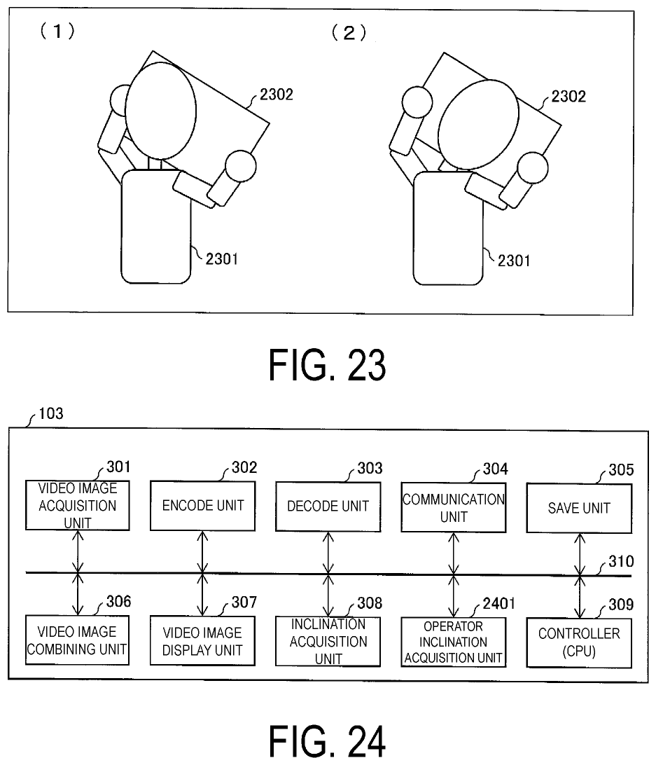

Another embodiment of the disclosure is as follows with description based on FIGS. 23 to 25. Note that, for convenience of explanation, components illustrated in respective embodiments are designated by the same reference numerals as those having the same function, and the descriptions of these components will be omitted.

When the operator inclines the operation terminal 103 during capturing, a posture of the operator includes a case where a head is not inclined as illustrated in FIG. 23(1) and a case where the head is inclined as illustrated in FIG. 23(2).

In Embodiment 1, Embodiment 2, and Embodiment 3 above, when the head is not inclined, the operator and the instructor see a video image at the same inclination, so that the instructor can appropriately provide instructions.

However, when the head is inclined, a video image displayed on the instruction device 108 has an inclination different from that of a video image seen by the operator, so that operation instructions cannot be appropriately provided.

Thus, in the present embodiment, a method for acquiring an inclination of the head of the operator and controlling a video image processing method based on inclination information by using the acquired inclination of the head and inclination information acquired by the inclination acquisition unit 308 is used.

Only a difference between the embodiments 1 to 3 and the present embodiment will be described below.

Example of Block Configuration (Operation Terminal)

A block configuration of the operation terminal 103 in the present embodiment will be described using FIG. 24.

The difference between Embodiments 1 to 3 and the present embodiment is that an operator inclination acquisition unit 2401 is provided in the present embodiment.

A method for adopting the operator inclination acquisition unit 2401 may be any method capable of obtaining an inclination of the head of the operator and can be achieved by using, for example, the video image acquisition unit 301 of the operation terminal 103. A method for calculating the inclination of the head of the operator will be described later.

Method for Acquiring Inclination of Head of Operator

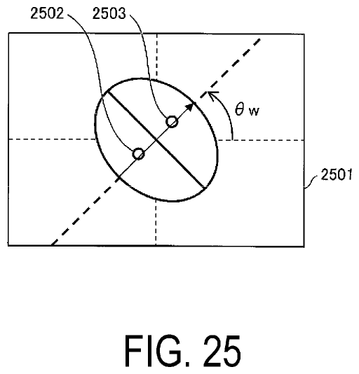

A method for acquiring inclination information about the operation terminal 103 in the present embodiment will be described using FIG. 25. The operator inclination acquisition unit 2401 detects a right eye 2502 and a left eye 2503 from a face image 2501 of an operator acquired by the video image acquisition unit 301, and calculates an inclination Ow of a face by using a straight line connecting from the right eye 2502 to the left eye 2503.

For example, the amount of Haar-like features can be used as the amount of features for detecting the right eye 2502 and the left eye 2503.

Video Image Processing Method Based on Inclination Information

A video image processing method based on inclination information in the present embodiment will be described. In Embodiment 1, Embodiment 2, and Embodiment 3, only inclination information about the operation terminal 103 is used to process a video image. In the present embodiment, a difference between the inclination information about the operation terminal 103 and inclination information about the operator is used to calculate an inclination formed by the operation terminal 103 and the operator and process a video image (Equation 12, Equation 13, Equation 14, and Equation 15).

$$\begin{matrix} [ Equation 12 ] & \\ {θ}_{f} = θ - {θ}_{w} & ( Equation 12 ) \\ [ Equation 13 ] & \\ {I}_{dst} ( x , y ) = {I}_{s r c} ( \begin{matrix}( x - c x ) \times cos {θ}_{f} - ( y - c y ) \times sin {θ}_{f} + cx , \\ ( x - cx ) \times sin {θ}_{f} + ( y - cy ) \times cos {0}_{f} + cy\end{matrix} ) & ( Equation 13 ) \\ [ Equation 14 ] & \\ ( {x}_{s}^{′} , {y}_{s}^{′} ) = ( \begin{matrix}( {x}_{s} - cx ) \times cos {θ}_{f} - ( {y}_{s} - cy ) \times sin {θ}_{f} + cx , \\ - ( {x}_{s} - cx ) \times sin {θ}_{f} + ( {y}_{s} - cy ) \times cos {θ}_{f} + cy\end{matrix} ) & ( Equation 14 ) \\ [ Equation 15 ] & \\ ( {x}_{g}^{′} , {y}_{g}^{′} ) = ( \begin{matrix}( {x}_{g} - cx ) \times cos {θ}_{f} + ( {y}_{g} - cy ) \times sin {θ}_{f} + cx , \\ - ( {x}_{g} - cx ) \times sin {θ}_{f} + ( {y}_{g} - cy ) \times cos {θ}_{f} + cy\end{matrix} ) & ( Equation 15 )\end{matrix}$$

As described above, a method for acquiring an inclination of the head of the operator and controlling a video image processing method for changing a displayed inclination angle of a captured video image based on inclination information by using the acquired inclination of the head and inclination information acquired by the inclination acquisition unit 308 can be provided.

### Embodiment 5

In the above-described embodiments, it is described that a video image displayed on the instruction device 108 is inclined, but this is not restrictive. The video image display unit 307 may be physically inclined by, for example, providing a display unit rotation adjusting unit (not illustrated) on the back of the video image display unit 307 and rotating the display unit based on inclination information acquired by the inclination acquisition unit.

In this way, an inclination of the operation terminal with which the operator on the operator side captures a video image can be matched with an inclination of a video image displayed on the instruction device, and the entire screen can be used as a display region of the video image display device 109. (A region (such as a black portion in FIG. 12) in which an image generated in image processing is not displayed is not generated).

Various existing rotation mechanisms such as a motor and a quadric crank mechanism can be used as the display unit rotation adjusting unit.

### With Regard to Embodiments 1 to 5

In each of the above-described embodiments, the configurations illustrated in the attached drawings, or the like, are merely examples, and the disclosure is not limited thereto, and modifications may appropriately be implemented within a range that exerts the effects of one aspect of the disclosure. In addition, modifications may be implemented within a range not departing from the scope of the objectives of one aspect of the disclosure.

In the description of each of the embodiments, it is assumed that respective constituent elements for enabling functions are different units, however, it is not required that units capable of being clearly and separately recognized are actually included in this way. In a device for supporting remote operation that enables the functions of each of the above-described embodiments, respective constituent elements for enabling the functions may be configured using actually different units, for example, or all the constituent elements may be implemented in an LSI chip. In other words, whatever the implementations are, it is sufficient that each of the constituent elements is included as the function. Meanwhile, each of the constituent elements of one aspect of the disclosure may be arbitrarily sorted out, and a disclosure including the sorted and selected constitutions is also included in one aspect of the disclosure.

Control blocks (particularly, the video image acquisition unit 301, the encode unit 302, the decode unit 303, the communication unit 304, the video image combining unit 306, the inclination acquisition unit 308, and the controller 309 of the operation terminal 103, the decode unit 401, the communication unit 402, the video image combining unit 404, and the controller 405 of the instruction device 108, and the encode unit 900, the decode unit 901, the communication unit 902, the marker tracking unit 904, the corrected video image generation unit 905, and the controller 906 of the management server) of the operation assistance device A may be achieved by a logic circuit (hardware) formed in an integrated circuit (IC chip) or the like, or may be achieved by software using a Central Processing Unit (CPU).

Further, a program for enabling functions described above in each of the embodiments may be recorded on a computer-readable recording medium to cause a computer system to read the program recorded on the recording medium for performing the processing of each of the units. The “computer system” here includes an OS and hardware components such as a peripheral device.

Further, the “computer system” includes environment for supplying a home page (or environment for display) in a case of utilizing a WWW system.

Furthermore, the “computer-readable recording medium” refers to a portable medium such as a flexible disk, a magneto-optical disk, a ROM, and a CD-ROM, and a storage device such as a hard disk built into the computer system. Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client. Furthermore, the program may be configured to realize some of the functions described above, and also may be configured to be capable of realizing the functions described above in combination with a program already recorded in the computer system.

Supplement

An operation assistance device (management server 200) according to Aspect 1 of the disclosure includes: a reception unit (communication unit 902) configured to receive a captured video image of a subject (operation subject 102) captured in the operation terminal 103; an inclination acquisition unit (communication unit 902) configured to acquire an inclination of the operation terminal 103 during capturing; the corrected video image generation unit 905 configured to change a displayed inclination angle of a received captured video image of the subject (operation subject 102) according to the inclination of the operation terminal 103 acquired by the inclination acquisition unit (communication unit 902); and an output unit (communication unit 902) configured to output a captured video image, in which the displayed inclination angle has been changed, to the outside.

According to the configuration above, the displayed inclination angle of the received captured video image of the subject (operation subject 102) is changed according to the inclination of the operation terminal 103. Thus, operation efficiency of both the operator operating with the operation terminal 103 and the instructor seeing the received captured video image of the subject (operation subject 102) can be enhanced.

This can assist operation instructions from the instructor being appropriately provided to the operator.

In the operation assistance device (management server 200) according to Aspect 2 of the disclosure in Aspect 1, the corrected video image generation unit 905 may substantially match a perpendicular direction of the operation terminal 103 with a perpendicular direction of the received captured video image of the subject (operation subject 102).

According to the configuration above, a remote operation can be assisted while an inclination of the operation terminal 103 with which the operator on the operator side captures a video image is matched with an inclination of a video image displayed on the video image display device 109 on the instructor side.

Further, a remote operation can be assisted while a captured direction of a video image is changed based on an analysis result of the captured video image and the video image is displayed on a screen on an instructor side.

In the operation assistance device (management server 200) according to Aspect 3 of the disclosure in Aspect 1 or 2, the corrected video image generation unit 905 may correct a video image such that an operation plane included in the subject (operation subject 102) is the front.

According to the configuration above, an instructor can capture the operation plane from the front.

In the operation assistance device (management server 200) according to aspect 4 of the disclosure in any one of aspects 1 to 3, the corrected video image generation unit 905 may change a displayed inclination angle of the received captured video image of the subject (operation subject 102) and a displayed inclination angle of an instruction video image generated with respect to the received captured video image of the subject (operation subject 102).

According to the configuration above, the instruction video image provided by the instruction device 108 is rotated according to an inclination of the operation terminal 103 and can be displayed on the operation terminal 103.

In the operation assistance device (management server 200) according to aspect 5 of the disclosure in any one of aspects 1 to 4, the corrected video image generation unit 905 may change a displayed inclination angle of the received captured video image of the subject (operation subject 102) based on an inclination of the operation terminal 103 and an inclination of the head of the operator 101 holding the operation terminal 103.

According to the configuration above, a remote operation can be assisted while a direction seen by the operator 101 is matched with an inclination of a video image displayed on the instructor 107 side according to the inclination of the head of the operator 101 and the inclination of the operation terminal 103.

An operation assistance method according to aspect 6 of the disclosure includes: a reception step of receiving a captured video image of a subject (operation subject 102) captured in the operation terminal 103; an inclination acquisition step of acquiring an inclination of the operation terminal 103 during capturing; a corrected video image generation step of changing a displayed inclination angle of a received captured video image of the subject (operation subject 102) according to the inclination of the operation terminal 103 acquired in the inclination acquisition step; and an output step of outputting a captured video image, in which the displayed inclination angle has been changed, to the outside.

According to the configuration above, the same effects as those of the operation assistance device (management server 200) according to Aspect 1 can be achieved.

An instruction device according to aspect 7 of the disclosure includes: a reception unit (communication unit 902) configured to receive a captured video image of a subject (operation subject 102) captured in the operation terminal 103; an inclination acquisition unit (communication unit 902) configured to acquire an inclination of the operation terminal 103 during capturing; the corrected video image generation unit 905 configured to change a displayed inclination angle of a received captured video image of the subject (operation subject 102) according to the inclination of the operation terminal 103 acquired by the inclination acquisition unit (communication unit 902); and a video image display unit (video image display device 109) configured to display the received captured video image of the subject (operation subject 102) in which the displayed inclination angle has been changed.

According to the configuration above, the same effects as those of the operation assistance device (management server 200) according to Aspect 1 can be achieved.

The operation assistance device (management server 200) according to each aspect of the disclosure may be implemented by a computer. In this case, an operation assistance control program of the operation assistance device configured to cause a computer to operate as each unit (software component) included in the operation assistance device A to implement the operation assistance device (management server 200) by the computer and a computer-readable recording medium configured to record the operation assistance control program are also included in the scope of the disclosure.

The disclosure is not limited to each of the above-described embodiments. It is possible to make various modifications within the scope of the claims. An embodiment obtained by appropriately combining technical elements each disclosed in different embodiments also falls within the technical scope of the disclosure. Further, when technical elements disclosed in the respective embodiments are combined, it is possible to form a new technical feature.

### CROSS-REFERENCE OF RELATED APPLICATION

This application claims the benefit of priority to JP 2015-250547 filed on Dec. 22, 2015, which is incorporated herein by reference in its entirety.

### REFERENCE SIGNS LIST

102 Operation subject (subject)
103 Operation terminal (terminal)
108 Instruction device
109 Video image display device (video image display unit)
200 Management server (operation assistance device)
902 Communication unit (reception unit, inclination acquisition unit, output unit)
905 Corrected video image generation unit

1-10. (canceled)

11. An operation assistance device comprising:
a reception circuitry configured to receive a captured video image;
a corrected video image generation circuitry configured to change a displayed inclination angle of a received captured video image based on a difference between a capturing inclination of a terminal that captures the captured video image and an inclination of a head of an operator holding the terminal; and
an output circuitry configured to output a captured video image, in which the displayed inclination angle has been changed, to an outside.

12. The operation assistance device according to claim 11, wherein
the captured video image is a captured video image of a subject captured in a terminal, and
the capturing inclination is an inclination of the terminal during capturing.

13. The operation assistance device according to claim 11, wherein
the corrected video image generation circuitry is configured to substantially match the inclination of the head of the operator with an inclination of the captured video image.

14. The operation assistance device according to claim 11, wherein
the output circuitry is a video image display circuitry configured to display a captured video image in which the displayed inclination angle has been changed.

15. An operation assistance system comprising
the operation assistance device according to claim 11; and
the terminal,
the terminal being configured to detect a face of the operator, and
the inclination of the head of the operator being calculated based on the face of the operator.

16. The operation assistance system according to claim 15, wherein
the terminal includes an image capturing circuitry configured to capture an image of the face of the operator; and
the inclination of the head of the operator is calculated based on an image captured by the image capturing circuitry.

17. The operation assistance system according to claim 15, wherein
the terminal is a smartphone or a tablet.

18. The operation assistance system according to claim 15, wherein
a display circuitry of the terminal is rotated based on the capturing inclination.

19. An operation assistance system comprising an operation assistance device and a terminal,
the operation assistance device including:
a reception circuitry configured to receive a captured video image;
a corrected video image generation circuitry configured to change a displayed inclination angle of a received captured video image based on a capturing inclination of the terminal that captures the captured video image; and
an output circuitry configured to output a captured video image, in which the displayed inclination angle has been changed, to an outside,
the terminal being configured to change, based on the capturing inclination, a displayed inclination angle of an instruction video image generated with respect to the captured video image in which the displayed inclination angle has been changed.

20. An operation assistance method comprising:
a reception step of receiving a captured video image;
a corrected video image generation step of changing a displayed inclination angle of a received captured video image based on a difference between a capturing inclination of a terminal that captures the captured video image and an inclination of a head of an operator holding the terminal; and
an output step of outputting a captured video image, in which the displayed inclination angle has been changed, to an outside.

21. A non-transitory computer-readable recording medium in which a program causing a computer to function as the operation assistance device according to claim 11 is recorded.
